(19) United States
(12) Patent Application Publication
(10) Pub. No.: US 2002/0056686 A1
(43) Pub. Date: May 16, 2002

(54) Chromatography and other adsorptions using modified carbon adsorbents

(76) Inventors: Agathagelos Kyrlidis, Malden, MA (US); Steven R. Reznek, Concord, MA (US); James A. Belmont, Acton, MA (US)

Correspondence Address: Martha Ann Finnegan, Esq., Cabot Corporation, Billerica Technical Center, 157 Concord Road, Billerica, MA, 01821-7001, US

(21) Appl. No.: 09/945,340

(22) Filed: Aug. 31, 2001

Related U.S. Application Data
(63) Continuation-in-part of application No. 09/654,182, filed on Sep. 1, 2000.
(63) Continuation-in-part of application No. 09/475,385, filed on Dec. 30, 1999.
Application No. 09/475,385 is a continuation of application No. 08/663,709, filed on Jun. 14, 1996, now abandoned.

(51) Int. Cl. B01D 15/08

(52) U.S. Cl. 210/656; 210/635; 210/198.2

(57) ABSTRACT

Separation devices and systems are described which have a stationary phase and a mobile phase, wherein the stationary phase contains carbonaceous material having attached at least one organic group. The stationary phase which is used in the present invention has the ability to dial in the selectivity by attaching the proper organic groups onto the carbonaceous material in order to achieve the desired separation. Various separation processes are described such as chromatography, electrophoresis, magnetic separations, membrane separations, and the like. The processes to accomplish these types of separations are also described.

This application is a continuation-in-part of U.S. patent application Ser. No. 09/654,182 filed Sep. 1, 2000 and also is a continuation-in-part of U.S. patent application Ser. No. 09/475,385 filed Dec. 30, 1999, which is a continuation of U.S. patent application Ser. No. 08/663,709 filed Jun. 14, 1996, all are incorporated in their entireties by reference herein.

### FIELD OF THE INVENTION

This invention relates to separation devices and processes as well as the use of modified carbonaceous materials as adsorbents and also relates to methods of using these adsorbents, including a method to increase the adsorption capacity and/or alter the adsorption affinity of carbonaceous materials capable of adsorbing an adsorbate.

### BACKGROUND OF THE INVENTION

Adsorption is an important operation in many industrial processes. The effectiveness of an adsorbent depends, primarily, on its surface area, pore structure, and surface chemistry. The nature of the adsorbate which is to be adsorbed frequently dictates the chemical nature of the adsorbent. For example, carbonaceous adsorbents are often used to selectively remove organic compounds from liquid, gaseous, or vapor media. Silica and alumina based adsorbents are employed to selectively adsorb polar adsorbates such as water, ammonia, and the like from similar media.

The efficacy of an adsorbent for a particular application is usually determined by the adsorption capacity and selectivity of the adsorbent for the adsorbate in question. The adsorption capacity may be measured per unit mass or per unit volume of the adsorbent. In general, the higher the adsorption capacity and selectivity of an adsorbent for a particular adsorbate, the more useful it is, since less of the adsorbent has to be used to effect the same removal of the adsorbate.

Carbonaceous materials, such as activated carbon, carbon black, and the like, represent an important class of adsorbents which are used in many fields such as separation, purification, and waste treatment, among others. Because of their widespread use, any method for improving the adsorption properties of carbonaceous adsorbents for a particular adsorbate can have a large impact on the efficacy and economy of the processes utilizing them. Therefore, attempts have been made in the past to modify the surface chemistry of carbonaceous adsorbents. The methods employed for their modification can be broadly classified into physical and chemical means. In surface modification by physical means, a species is deposited on the surface of the carbonaceous adsorbent to form a layer which then changes its adsorption properties. However, such modification techniques have limited utility because the deposited layer is easily removed. In surface modification by chemical means, the modifying species is attached to the carbon surface by a chemical bonding mechanism.

The characteristics of the adsorption isotherm, representing the relationship between the extent of adsorption and adsorbate concentration or adsorbate partial pressure at a fixed temperature, is also of importance. As described by Sircar et al. in “Activated Carbon for Gas Separation and Storage,” Carbon, Vol. 34, No. 1, pp. 1-12 (1996), the characteristics of the preferred adsorption isotherm will depend on the separation process being employed. For example, in cases where adsorbent regeneration is effected by a pressure swing, the preferred adsorbent is one with a moderate affinity for the adsorbate. When the adsorbate is strongly adsorbed, that is, when it has a strong affinity for the adsorbent, regeneration becomes difficult and energy intensive. On the other hand, when the adsorbent exhibits a weak affinity for the adsorbate, it has a small adsorption capacity at low adsorbent partial pressures and, hence, the adsorption mass transfer zone becomes very long. Thus, the availability of a method for altering the affinity of an adsorbent for an adsorbate is advantageous.

Thus, any method for increasing the adsorption capacity and/or modifying the adsorption affinity of the adsorbent enhances its usefulness in adsorption applications. As already noted, chemical modification can be used to alter the adsorptive properties of carbonaceous adsorbents. The range of chemical species which can be attached, however, is limited.

Bansal, Donnet and Stoeckli (in Chapter 5 of Active Carbon, Marcel Dekker, Inc., 1988) have reviewed different techniques of carbon surface modification. Physical impregnation methods are described, as are methods that rely on chemical reactions with various species to modify the surface of the carbon. Some of the chemical surface modification techniques described by Bansal et al. are oxidation, halogenation, sulfonation, and ammoniation. Several of these techniques require treatment of the carbon at elevated temperatures. Another technique involving oxidation of the carbon with HNO₃ in the presence of a catalyst, has been described by Sircar and Golden (U.S. Pat. No. 4,702,749). However, these techniques have certain disadvantages apparent to those familiar with the field.

In chromatography and other separation methods, there is a certain amount of selectivity and efficiency that is necessary in order for the stationary phase to separate the various components in a mixture. For this reason, carbon products, such as carbon black, graphite, and activated carbon, have not been used as a standard stationary phase in certain separation systems because carbon is a strong non-specific adsorbent. This has been disappointing in the past, because carbon products, otherwise, would have many advantages over commercially available adsorbents. For instance, there are no corrosion problems with carbon products, which are stable at a wide pH range unlike silica particles which are stable only in the pH range of 1-8, nor are there any swelling problems with carbon products, which are stable in all organic solvents, unlike polysaccharide and/or polymer-based chromatographic particles, which have solvent restrictions. In addition, carbon products can be subjected to large temperature ranges and/or extreme pressures which would be beneficial for certain types of adsorptions, such as temperature swings used in some types of chromatography. In addition, with certain separation processes used in the production of biopharmaceuticals for clinical applications, the sterilization requirements or recommendations provide for the use of hot sodium hydroxide. With such sterilization procedures, the current popular stationary phases such as silica columns, cannot be used. Further, the polymeric columns such as cellulose polymers, are chemically but not physically stable to such sterilization treatments; in addition polymeric stationary phases are typically less efficient than metal oxide based stationary phases, resulting in poorer separations.

Accordingly, there is a need to provide a new class of adsorbents and new separation devices which can make use of carbon materials that have the advantages described above but are capable of being selective in their adsorption in order to serve as suitable adsorbents in separation processes such as chromatography.

All patents, publications, and applications referenced throughout this application are incorporated in their entirety by reference herein and form a part of the present application.

### SUMMARY OF THE INVENTION

To achieve these and other advantages and in accordance with the purposes of the present invention, as embodied and broadly described herein, the present invention relates to an adsorbent composition containing a modified carbonaceous material capable of adsorbing an adsorbate.

The present invention also relates to a separation device having a mobile phase and a stationary phase, wherein said stationary phase is a carbonaceous material having attached at least one organic group. The carbonaceous material having attached at least one organic group is capable of adsorbing one or more chemical species present in a mixture.

The present invention further relates to a chromatography column containing a column having a stationary phase and a mobile phase. The stationary phase is at least a carbonaceous material having attached at least one organic group wherein the carbonaceous material having at least one organic group is capable of adsorbing at least one chemical species present in a mixture.

The present invention further relates to a method for conducting chromatography on a substance and involves passing the substance through a column having a stationary phase and a mobile phase, wherein the stationary phase is at least a carbonaceous material having attached at least one organic group. The chromatography can be, for instance, a size exclusion chromatography, an affinity-type chromatography, an adsorption-desorption chromatography, or variations thereof or combinations thereof. Also, the chromatography can be a reverse phase chromatography, ion exchange chromatography, supercritical fluid chromatography, hydrophobic interaction chromatography, or chiral chromatography.

The present invention, in addition, relates to bioseparations using the chromatography methods described above.

The present invention also relates to separations using electrophoresis wherein the stationary phase is a carbonaceous material having attached at least one organic group.

The present invention further relates to a separation device containing a membrane wherein said membrane contains a carbonaceous material having attached at least one organic group.

The separation device can also be a magnetic separation device or a reverse osmosis device wherein the stationary phase or the membrane contains a carbonaceous material having attached at least one organic group.

Another embodiment of the present invention relates to a method to increase the adsorption capacity of a carbonaceous material capable of adsorbing an adsorbate or altering the adsorption isotherm of the adsorbate on the adsorbent, for instance, to allow an easier regeneration of the adsorbent. In this method, at least one organic group capable of increasing the adsorption capacity of a carbonaceous material is attached to the carbonaceous material.

The present invention, in addition, relates to a method of adsorbing an adsorbate and includes the step of contacting the adsorbate with a carbonaceous material which has been modified by attaching an organic group. The modified carbonaceous material is capable of adsorbing the adsorbate and at least one organic group is attached to the carbonaceous material.

Additional features and advantages of the present invention will be set forth in part in the description which follows, and in part will be apparent from the description, or may be learned by practice of the present invention. The objectives and other advantages of the present invention will be realized and attained by means of the elements and combinations particularly pointed out in the written description and appended claims.

It is to be understood that both the foregoing general description and the following detailed description are exemplary and explanatory only and are intended to provide further explanation of the present invention, as claimed.

The accompanying figures, which are incorporated in and constitute a part of this specification, illustrate several embodiments of the present invention and together with the description, serve to explain the principles of the present invention.

### BRIEF DESCRIPTION OF THE DRAWINGS

FIG. 1 is a graph plotting the amount of water adsorption on modified and unmodified carbon black.

FIG. 2 is a graph plotting the amount of water adsorption on modified and unmodified activated carbon.

FIG. 3 is a graph plotting the amount of water adsorption on modified and unmodified carbon black per unit surface area.

FIG. 4 is a graph plotting the amount of water adsorption on modified and unmodified activated carbon per unit surface area.

FIG. 5 is a graph plotting the amount of CO₂ adsorption on modified and unmodified carbon black at 273 K.

FIG. 6 is a graph plotting the concentration of supernatant vs. the concentration of loaded Bovine Serum Albumin (BSA) solution in the presence of various carbonaceous materials.

FIGS. 7-11 are various graphs plotting the separation of various analytes resulting from using various phases of the present invention.

### DETAILED DESCRIPTION OF THE PRESENT INVENTION

The present invention relates to separation devices which typically have a stationary phase. The stationary phase, for purposes of the present invention, is a carbonaceous material having attached at least one organic group. This material is also known, once the organic group is attached, as a modified carbonaceous material for purposes of the present invention. The organic group is preferably attached (e.g., chemically) to the surfaces of the carbonaceous material, preferably by covalent bonds.

One preferred separation device is a chromatography column which, for purposes of the present invention, contains a column having a mobile phase and a stationary phase. The stationary phase is at least the modified carbonaceous material of the present invention. The mobile phase can be any conventional mobile phase used in the separation of chemical compounds or species from a mixture, such as solvents and the like. The present invention further relates to a method for conducting chromatography on a substance or mixture which involves passing the substance through a column packed with at least the modified carbonaceous material as the stationary phase and the mobile phase. The type of chromatography that can be accomplished by the present invention includes, but is not limited to, size exclusion chromatography and affinity chromatography (wherein the affinity between the modified carbonaceous material and the different chemical species in the mixture is different such that separation occurs at different rates). Another type of chromatography that can be accomplished by the present invention is adsorption-desorption chromatography, reverse phase chromatography, ion exchange chromatography, hydrophobic interaction chromatography, chiral chromatography, capillary liquid chromatography, supercritical fluid chromatography, or electrochromatography.

Chromatographic separation of proteins and other biomolecules can also be accomplished by the present invention. An example of such a bioseparation would involve the use of a stationary phase wherein polyols or polyethylene glycol compounds are attached on the carbonaceous material. Another example of a bioseparation would involve the use of a stationary phase wherein benzoic acid or benzenesulfonic groups are attached to the surface of the carbonaceous material.

Typically, a chromatographic system contains a mobile phase, a stationary phase, a pumping system, and a detector. Generally, the stationary phase contains insoluble particles which are preferably spherical and preferably range in size from about 1 micron to about 500 microns, and most preferably 2 to 5 microns, for analytical chromatography and 10 to 40 microns for preparative chromatographic applications. These particles have a surface area ranging from about 1 to about 500 m²/g, preferably 50 to 200 m²/g, and a mean pore diameter ranging from about 20 to about 20,000 Angstrom, preferably 60 to 1,000 Angstrom. The choice of these particles depends on the physical, chemical, and/or biological interactions that need to be exploited by the separation. Conventional stationary phases, such as silica, agarose, polystyrene-divinylbenzene, polyacrylamide, dextrin, hydroxyapatite, cross-linked polysaccharides, and polymethacrylates are functionalized with certain groups in order to accomplish the selective separation of particular chemical compounds from a mixture. The precise functional groups that accomplish this desired specification are set forth, for instance, in Garcia, Bonen et al., “Bioseparation Process Science,” Blackwell Science (1999), incorporated in its entirety by reference herein. In preferred instances, the functional groups described in Garcia et al. are the organic groups attached to the carbonaceous materials based on the present invention or are part of the organic group attached to the carbonaceous materials (e.g., the functional groups of Garcia et al. attached to the carbonaceous material through at least one aromatic group or alkyl group, wherein the aromatic group or alkyl group are preferably directly attached to the carbonaceous material).

Another form of separation is electrophoresis which uses an applied electric field to produce directed movement of charged molecules. The process is similar to chromatographic methods in that a fixed barrier phase or stationary phase is used to facilitate separation. In the present invention, electrophoresis can be accomplished by using a stationary phase which contains the modified carbonaceous material of the present invention.

Similarly, magnetic separations, such as magnetic bioseparations, can be accomplished using the modified magnetic carbonaceous materials of the present invention as the stationary phase.

In addition, membrane separations, such as reverse osmosis, can be accomplished by forming the membrane such that it contains modified carbonaceous materials. The membrane can be formed by dispersing the modified carbonaceous material in a polymer and casting the polymer mixture to form a membrane. Another way to make the membrane is to form a conventional membrane and then surface modify the membrane to attach organic groups onto the membrane. Membranes can be used in a variety of separation techniques, including protein separations and/or metal removal.

Generally, any separation technique which involves the use of a stationary phase can be improved by the present invention. In particular, the stationary phase can be or can contain the modified carbonaceous material of the present invention. Upon knowing the desired chemical compound or species to be separated, the modified carbonaceous material can be tailored to be selective to the targeted chemical species by attaching an organic group or organic groups onto the carbonaceous material to suit the separation needed. Since many functional groups are known to cause particular selectivity in separations, these groups can be attached onto the carbonaceous material to form the modified carbonaceous material of the present invention and achieve the desired selectivity for separation processes.

In one embodiment, an adsorbent composition of the present invention contains a modified carbonaceous material capable of adsorbing an adsorbate wherein at least one organic group is attached to the carbonaceous material.

The carbonaceous material capable of adsorbing an adsorbate includes, but is not limited to, activated carbon, carbon black, graphite, or other carbonaceous material obtained by the pyrolysis of cellulosic, fuel oil, polymeric, or other precursors. Additional examples include, but are not limited to, carbon fibers, carbon cloth, vitreous carbon, carbon aerogels, pyrolized ion exchange resins, pyrolized polymer resins, mesoporous carbon microbeads, pelleted carbon powder, nanotubes, buckyballs, silicon-treated carbon black, silica-coated carbon black, metal-treated carbon black, densified carbon black, carbon clad silica, alumina, and ceria particles, and combinations thereof or activated versions thereof. The carbonaceous material can also be a waste product or by-product of carbonaceous material obtained by pyrolysis, including carbonized polymeric particles (e.g., polydivinylbenzene based chromatographic particles, or sulfonated polydivinylbenzene/polystyrene particles). Preferably, the carbonaceous material is activated carbon or carbon black capable of adsorbing an adsorbate. Commercial examples of carbon black include, but are not limited to, Black Pearls® 2000 carbon black, Black Pearls® 430 carbon black, Black Pearls® 900 carbon black, and Black Pearls® 120 carbon black, all available from Cabot Corporation. Commercial examples of activated carbon include Darco S51, available from Norit; Sorbonorit 3, available from Norit; Ambersorb adsorbent (available from Rohm and Haas); Hypercarb carbon particle (available from ThermoHyperSil); TosoHaas carbon materials; and BPL activated carbon from Calgon. The carbonaceous material modified by the procedures described herein may be a microporous or mesoporous activated carbon in granular or pellet form; a carbon black of different structures in fluffy or pelleted form; or any other carbonaceous material whose applicability to this invention is apparent to those skilled in the art, such as carbon fibers or carbon cloth. The choice of carbonaceous material used eventually depends on a variety of different factors, including the application for which it is intended. Each of these types of carbonaceous material has the ability to adsorb at least one adsorbate. A variety of BET surface areas, micropore volumes, and total pore volumes are available depending on the desired end use of the carbonaceous material.

Carbonaceous materials include, but are not limited to, material obtained by the compaction of small carbon particles and other finely divided forms of carbon as long as the carbon has the ability to adsorb at least one adsorbate and is capable of being chemically modified in accordance with the present invention.

Also, for purposes of the present invention, the carbonaceous material can be an aggregate comprising a carbon phase and a silicon-containing species phase. A description of this aggregate as well as means of making this aggregate is described in PCT Publication No. WO 96/37547 and WO 98/47971 as well as U.S. Pat. Nos. 5,830,930; 5,869,550; 5,877,238; 5,919,841; 5,948,835; and 5,977,213. All of these patents and publications are hereby incorporated in their entireties herein by reference.

The carbonaceous material for purposes of the present invention, can also be an aggregate comprising a carbon phase and metal-containing species phase where the metal-containing species phase can be a variety of different metals such as magnesium, calcium, titanium, vanadium, cobalt, nickel, zirconium, tin, antimony, chromium, neodymium, lead, tellurium, barium, cesium, iron, molybdenum, aluminum, and zinc, and mixtures thereof The aggregate comprising the carbon phase and a metal-containing species phase is described in U.S. Pat. No. 6,017,980, also hereby incorporated in its entirety herein by reference.

Also, for purposes of the present invention, the carbonaceous material includes a silica-coated carbon black, such as that described in U.S. Pat. No. 5,916,934 and PCT Publication No. WO 96/37547, published Nov. 28, 1996, also hereby incorporated in their entirety herein by reference.

The carbonaceous material described above is then modified by the attachment of an organic group to the carbonaceous material. Preferred processes for attaching an organic group to a carbonaceous material and examples or organic groups are described in detail in U.S. Pat. Nos. 5,554,739; 5,559,169; 5,571,311; 5,575,845; 5,630,868; 5,672,198; 5,698,016; 5,837,045; 5,922,118; 5,968,243; 6,042,643; 5,900,029; 5,955,232; 5,895,522; 5,885,335; 5,851,280; 5,803,959; 5,713,988; and 5,707,432; and International Patent Publication Nos. WO 97/47691; WO 99/23174; WO 99/31175; WO 99/51690; WO 99/63007; and WO 00/22051; all incorporated in their entirety by reference herein. These processes can be preferably used in preparing the modified carbon adsorbents of the present invention and permit the attachment of an organic group to the carbonaceous material via a chemical reaction. As indicated above, the organic group attached to the carbonaceous material is one preferably capable of increasing the adsorption capacity and/or selectivity of the carbonaceous material and/or enhancing the resolution of solute peaks in chromatographic separations.

As indicated above, once the desired separation technique is chosen and the particular chemical species preferably known, a particular functional group or multiple functional groups can be chosen to be attached onto the carbonaceous material in order to accomplish the selectivity needed to conduct the separation process. For instance, as set forth in Garcia et al., heparin is used in the separation of lipoproteins, accordingly, heparin can be attached onto carbonaceous material in order to accomplish the desired separation. Similarly, when cationic exchange processes are needed, a sulfonic acid, for instance, can be attached on a carbonaceous material and when anionic exchanges are needed, a quaternary amine can be attached onto the carbonaceous material. Thus, with the present invention, and the knowledge possessed by one skilled in the art, separation techniques can be conducted using modified carbonaceous material to achieve the selectivity desired.

Thus, the present invention provides a carbonaceous material which is resistant to corrosion, swelling, and/or extreme temperatures and pressures, but also provides the desired selectivity. In essence, the present invention gives the separation field the best of both worlds, namely, selectivity combined with a resilient stationary phase without any losses in the efficiency of separation.

A preferred process for attaching an organic group to the carbonaceous materials involves the reaction of at least one diazonium salt with a carbonaceous material in the absence of an externally applied current sufficient to reduce the diazonium salt. That is, the reaction between the diazonium salt and the carbonaceous material proceeds without an external source of electrons sufficient to reduce the diazonium salt. Mixtures of different diazonium salts may be used. This process can be carried out under a variety of reaction conditions and in any type of reaction medium, including both protic and aprotic solvent systems or slurries.

In another preferred process, at least one diazonium salt reacts with a carbonaceous material in a protic reaction medium. Mixtures of different diazonium salts may be used in this process. This process can also be carried out under a variety of reaction conditions.

Preferably, in both processes, the diazonium salt is formed in situ. If desired, in either process, the modified carbonaceous material can be isolated and dried by means known in the art. Furthermore, the modified carbonaceous material can be treated to remove impurities by known techniques. The various preferred embodiments of these processes are discussed below.

The processes can be carried out under a wide variety of conditions and in general are not limited by any particular condition. The reaction conditions must be such that the particular diazonium salt is sufficiently stable to allow it to react with the carbonaceous material. Thus, the processes can be carried out under reaction conditions where the diazonium salt is short lived. The reaction between the diazonium salt and the carbonaceous material occurs, for example, over a wide range of pH and temperature. The processes can be carried out at acidic, neutral, and basic pH. Preferably, the pH ranges from about 1 to 9. The reaction temperature may preferably range from 0° C. to 100° C.

Diazonium salts, as known in the art, may be formed for example by the reaction of primary amines with aqueous solutions of nitrous acid. A general discussion of diazonium salts and methods for their preparation is found in Morrison and Boyd, Organic Chemistry, 5th Ed., pp. 973-983, (Allyn and Bacon, Inc. 1987) and March, Advanced Organic Chemistry: Reactions, Mechanisms, and Structures, 4th Ed., (Wiley, 1992). According to this invention, a diazonium salt is an organic compound having one or more diazonium groups.

The diazonium salt may be prepared prior to reaction with the carbonaceous material or, more preferably, generated in situ using techniques known in the art. In situ generation also allows the use of unstable diazonium salts such as alkyl diazonium salts and avoids unnecessary handling or manipulation of the diazonium salt. In particularly preferred processes, both the nitrous acid and the diazonium salt are generated in situ.

A diazonium salt, as is known in the art, may be generated by reacting a primary amine, a nitrite and an acid. The nitrite may be any metal nitrite, preferably lithium nitrite, sodium nitrite, potassium nitrite, or zinc nitrite, or any organic nitrite such as for example isoamylnitrite or ethylnitrite. The acid may be any acid, inorganic or organic, which is effective in the generation of the diazonium salt. Preferred acids include nitric acid, HNO₃, hydrochloric acid, HCl, and sulfuric acid, H₂SO₄.

The diazonium salt may also be generated by reacting the primary amine with an aqueous solution of nitrogen dioxide. The aqueous solution of nitrogen dioxide, NO₂/H₂O, provides the nitrous acid needed to generate the diazonium salt.

Generating the diazonium salt in the presence of excess HCl may be less preferred than other alternatives because HCl is corrosive to stainless steel. Generation of the diazonium salt with NO₂/H₂O has the additional advantage of being less corrosive to stainless steel or other metals commonly used for reaction vessels. Generation using H₂SO₄/NaNO₂ or HNO₃/NaNO₂ are also relatively non-corrosive.

In general, generating a diazonium salt from a primary amine, a nitrite, and an acid requires two equivalents of acid based on the amount of amine used. In an in situ process, the diazonium salt can be generated using one equivalent of the acid. When the primary amine contains a strong acid group, adding a separate acid may not be necessary. The acid group or groups of the primary amine can supply one or both of the needed equivalents of acid. When the primary amine contains a strong acid group, preferably either no additional acid or up to one equivalent of additional acid is added to a process of the invention to generate the diazonium salt in situ. A slight excess of additional acid may be used. One example of such a primary amine is para-aminobenzenesulfonic acid (sulfanilic acid).

In general, diazonium salts are thermally unstable. They are typically prepared in solution at low temperatures, such as 0-5° C., and used without isolation of the salt. Heating solutions of some diazonium salts may liberate nitrogen and form either the corresponding alcohols in acidic media or the organic free radicals in basic media.

However, the diazonium salt need only be sufficiently stable to allow reaction with the carbonaceous material. Thus, the processes can be carried out with some diazonium salts otherwise considered to be unstable and subject to decomposition. Some decomposition processes may compete with the reaction between the carbonaceous material and the diazonium salt and may reduce the total number of organic groups attached to the carbonaceous material. Further, the reaction may be carried out at elevated temperatures where many diazonium salts may be susceptible to decomposition. Elevated temperatures may also advantageously increase the solubility of the diazonium salt in the reaction medium and improve its handling during the process. However, elevated temperatures may result in some loss of the diazonium salt due to other decomposition processes.

Reagents can be added to form the diazonium salt in situ, to a suspension of carbonaceous material in the reaction medium, for example, water. Thus, a carbonaceous material suspension to be used may already contain one or more reagents to generate the diazonium salt and the process accomplished by adding the remaining reagents.

Reactions to form a diazonium salt are compatible with a large variety of functional groups commonly found on organic compounds. Thus, only the availability of a diazonium salt for reaction with a carbonaceous material limits the processes of the invention.

The processes can be carried out in any reaction medium which allows the reaction between the diazonium salt and the carbonaceous material to proceed. Preferably, the reaction medium is a solvent-based system. The solvent may be a protic solvent, an aprotic solvent, or a mixture of solvents. Protic solvents are solvents, like water or methanol, containing a hydrogen attached to an oxygen or nitrogen and thus are sufficiently acidic to form hydrogen bonds. Aprotic solvents are solvents which do not contain an acidic hydrogen as defined above. Aprotic solvents include, for example, solvents such as hexanes, tetrahydrofuran (THF), acetonitrile, and benzonitrile. For a discussion of protic and aprotic solvents see Morrison and Boyd, Organic Chemistry, 5th Ed., pp.228-231, (Allyn and Bacon, Inc. 1987).

The processes are preferably carried out in a protic reaction medium, that is, in a protic solvent alone or a mixture of solvents which contains at least one protic solvent. Preferred protic media include, but are not limited to water, aqueous media containing water and other solvents, alcohols, and any media containing an alcohol, or mixtures of such media.

The reaction between a diazonium salt and a carbonaceous material can take place with any type of carbonaceous material, for example, in finely divided state or pelleted form. In one embodiment designed to reduce production costs, the reaction occurs during a process for forming carbonaceous material pellets. For example, a carbonaceous material product of the invention can be prepared in a dry drum by spraying a solution or slurry of a diazonium salt onto a carbonaceous material. Alternatively, the carbonaceous material product can be prepared by pelletizing a carbonaceous material in the presence of a solvent system, such as water, containing the diazonium salt or the reagents to generate the diazonium salt in situ. Aqueous solvent systems are preferred.

In general, the processes produce inorganic by-products, such as salts. In some end uses, such as those discussed below, these by-products may be undesirable. Several possible ways to produce a carbonaceous material product without unwanted inorganic by-products or salts are as follows:

First, the diazonium salt can be purified before use by removing the unwanted inorganic by-product using means known in the art. Second, the diazonium salt can be generated with the use of an organic nitrite as the diazotization agent yielding the corresponding alcohol rather than an inorganic salt. Third, when the diazonium salt is generated from an amine having an acid group and aqueous NO₂, no inorganic salts are formed. Other ways may be known to those of skill in the art.

In addition to the inorganic by-products, the process may also produce organic by-products. They can be removed, for example, by extraction with organic solvents. Other ways of obtaining products without unwarranted organic by-products may be known to those of skill in the art, and include washing or removal of ions by reverse osmosis.

The reaction between a diazonium salt and a carbonaceous material forms a carbonaceous material product having an organic group attached to the carbonaceous material. The diazonium salt may contain the organic group to be attached to the carbonaceous material. It may be possible to produce the carbonaceous material products of this invention by other means known to those skilled in the art.

The organic group may be an aliphatic group, a cyclic organic group, or an organic compound having an aliphatic portion and a cyclic portion. As discussed above, the diazonium salt employed can be derived from a primary amine having one of these groups and being capable of forming, even transiently, a diazonium salt. The organic group may be substituted or unsubstituted, branched or unbranched. Aliphatic groups include, for example, groups derived from alkanes, alkenes, alcohols, ethers, aldehydes, ketones, carboxylic acids, and carbohydrates. Cyclic organic groups include, but are not limited to, alicyclic hydrocarbon groups (for example, cycloalkyls, cycloalkenyls), heterocyclic hydrocarbon groups (for example, pyrrolidinyl, pyrrolinyl, piperidinyl, morpholinyl, and the like), aryl groups (for example, phenyl, naphthyl, anthracenyl, and the like), and heteroaryl groups (imidazolyl, pyrazolyl, pyridinyl, thienyl, thiazolyl, furyl, indolyl, and the like). As the steric hindrance of a substituted organic group increases, the number of organic groups attached to the carbonaceous material from the reaction between the diazonium salt and the carbonaceous material may be diminished.

When the organic group is substituted, it may contain any functional group compatible with the formation of a diazonium salt. Functional groups include, but are not limited to, R, OR, COR, COOR, OCOR, carboxylate salts such as COOLi, COONa, COOK, COO³¹ NR₄⁺, halogen, CN, NR₂, SO₃H, sulfonate salts such as SO₃Li, SO₃Na, SO₃K, SO₃⁻NR₄⁺, OSO₃H, OSO₃⁻ salts, NR(COR), CONR₂, NO₂, PO₃H₂, phosphonate salts such as PO₃HNa and PO₃Na₂, phosphate salts such as OPO₃HNa and OPO₃Na₂, N═NR, NR₃⁺X⁻, PR₃^{+X}⁻, SₖR, SSO₃H, SSO₃⁻ salts, SO₂NRR′, SO₂SR, SNRR′, SNQ, SO₂NQ, CO₂NQ, S-(1,4-piperazinediyl)-SR, 2-(1,3-dithianyl) 2-(1,3-dithiolanyl), SOR, and SO₂R. R and R′, which can be the same or different, are independently hydrogen, branched or unbranched C₁-C₂₀ substituted or unsubstituted, saturated or unsaturated hydrocarbon, e.g., alkyl, alkenyl, alkynyl, substituted or unsubstituted aryl, substituted or unsubstituted heteroaryl, substituted or unsubstituted alkylaryl, or substituted or unsubstituted arylalkyl. The integer k ranges from 1-8 and preferably from 2-4. The anion X⁻ is a halide or an anion derived from a mineral or organic acid. Q is (CH₂)_{w}, (CH₂)ₓO(CH₂)_{z}, (CH₂)ₓNR(CH₂)_{z}, or (CH₂)ₓS(CH₂)_{z}, where w is an integer from 2 to 6 and x and z are integers from 1 to 6. In the above formula, specific examples of R and R′ are NH₂—C₆H₄—, CH₂CH₂—C₆H₄—NH₂, CH₂—C₆H₄—NH₂, and C₆H₅.

Another example of an organic group is an aromatic group of the formula A_{y}Ar—, which corresponds to a primary amine of the formula A_{y}ArNH₂. In this formula, the variables have the following meanings: Ar is an aromatic radical such as an aryl or heteroaryl group. Ar can be selected from the group consisting of phenyl, naphthyl, anthracenyl, phenanthrenyl, biphenyl, pyridinyl, benzothiadiazolyl, and benzothiazolyl; A is a substituent on the aromatic radical independently selected from a preferred functional group described above or A is a linear, branched or cyclic hydrocarbon radical (preferably containing 1 to 20 carbon atoms), unsubstituted or substituted with one or more of those functional groups; and y is an integer from 1 to the total number of —CH radicals in the aromatic radical. For instance, y is an integer from 1 to 5 when Ar is phenyl, 1 to 7 when Ar is naphthyl, 1 to 9 when Ar is anthracenyl, phenanthrenyl, or biphenyl, or 1 to 4 when Ar is pyridinyl.

Another set of organic groups which may be attached to the carbonaceous material are organic groups substituted with an ionic or an ionizable group as a functional group. An ionizable group is one which is capable of forming an ionic group in the medium of use. The ionic group may be an anionic group or a cationic group and the ionizable group may form an anion or a cation.

Ionizable functional groups forming anions include, for example, acidic groups or salts of acidic groups. The organic groups, therefore, include groups derived from organic acids. Preferably, when it contains an ionizable group forming an anion, such an organic group has a) an aromatic group or a C₁-C₁₂ alkyl group and b) at least one acidic group having a pKa of less than 11, or at least one salt of an acidic group having a pKa of less than 11, or a mixture of at least one acidic group having a pKa of less than 11 and at least one salt of an acidic group having a pKa of less than 11. The pKa of the acidic group refers to the pKa of the organic group as a whole, not just the acidic substituent. More preferably, the pKa is less than 10 and most preferably less than 9. Preferably, the aromatic group or the C₁-C₁₂ alkyl group of the organic group is directly attached to the carbonaceous material. The aromatic group may be further substituted or unsubstituted, for example, with alkyl groups. The organic group can be a phenyl or a naphthyl group and the acidic group is a sulfonic acid group, a sulfinic acid group, a phosphonic acid group, or a carboxylic acid group. The organic group may also contain one or more asymmetric centers. Examples of these acidic groups and their salts are discussed above. The organic group can be a substituted or unsubstituted sulfophenyl group or a salt thereof; a substituted or unsubstituted (polysulfo)phenyl group or a salt thereof, a substituted or unsubstituted sulfonaphthyl group or a salt thereof, or a substituted or unsubstituted (polysulfo)naphthyl group or a salt thereof. An example of a substituted sulfophenyl group is hydroxysulfophenyl group or a salt thereof.

Specific organic groups having an ionizable functional group forming an anion (and their corresponding primary amines for use in a process according to the invention) are p-sulfophenyl (p-sulfanilic acid), 4-hydroxy-3-sulfophenyl (2-hydroxy-5-amino-benzenesulfonic acid), and 2-sulfoethyl (2-aminoethanesulfonic acid).

Amines represent examples of ionizable functional groups that form cationic groups. For example, amines may be protonated to form ammonium groups in acidic media.

Preferably, an organic group having an amine substituent has a pKb of less than 5. Quaternary ammonium groups (—NR₃⁺) and quaternary phosphonium groups (—PR₃⁺) also represent examples of cationic groups. The organic group can contain an aromatic group such as a phenyl or a naphthyl group and a quaternary ammonium or a quaternary phosphonium group. The aromatic group is preferably directly attached to the carbonaceous material. Quaternized cyclic amines, and even quaternized aromatic amines, can also be used as the organic group. Thus, N-substituted pyridinium compounds, such as N-methyl-pyridyl, can be used in this regard. Examples of organic groups include, but are not limited to, (C₅H₄N)C₂H₅⁺X⁻, C₆H₄(NC₅H₅)⁺X⁻, C₆H₄COCH₂N(CH₃)₃⁺X⁻, C₆H₄COCH₂(NC₅H₅)⁺X⁻, (C₅H₄N)CH₃⁺X⁻, and

C₆H₄CH₂N(CH₃)₃⁺X⁻, where X⁻ is a halide or an anion derived from a mineral or organic acid.

Aromatic sulfides encompass another group of organic groups. These aromatic sulfides can be represented by the formulas Ar(CH₂)_{q}Sₖ(CH₂)ᵣAr′ or A—(CH₂)_{q}S_{K}(CH₂)ᵣAr″ wherein Ar and Ar′ are independently substituted or unsubstituted arylene or heteroarylene groups, Ar″ is an aryl or heteroaryl group, k is 1 to 8 and q and r are 0-4. Substituted aryl groups would include substituted alkylaryl groups. Examples of arylene groups include phenylene groups, particularly p-phenylene groups, or benzothiazolylene groups. Aryl groups include phenyl, naphthyl and benzothiazolyl. The number of sulfurs present, defined by k preferably ranges from 2 to 4. Examples of carbonaceous material products are those having an attached aromatic sulfide organic group of the formula —(C₆H₄)—Sₖ(C₆H₄)—, where k is an integer from 1 to 8, and more preferably where k ranges from 2 to 4. Other examples of aromatic sulfide groups are bis-para-(C₆H₄)—S₂—(C₆H₄)— and para-(C₆H₄)—S₂—(C₆H₅). The diazonium salts of these aromatic sulfide groups may be conveniently prepared from their corresponding primary amines, H₂N—Ar—Sₖ—Ar′—NH₂ or H₂N—Ar—Sₖ—Ar″. Groups include dithiodi-4,1-phenylene, tetrathiodi-4,1-phenylene, phenyldithiophenylene, dithiodi-4,1-(3-chlorophenylene), —(4-C₆H₄)—S—S—(2-C₇H₄NS), —(4-C₆H₄)—S—S—(4-C₆H₄)—OH, -6-(2-C₇H₃NS)—SH, —(4-C₆H₄)—CH₂CH₂—S—S—CH₂CH₂—(4-C₆H₄)—, —(4-C₆H₄)—CH₂CH₂—S—S—S—CH₂CH₂—(4-C₆H₄)—, —(2-C₆H₄)—S—S—(2-C₆H₄)—, —(3-C₆H₄)—S—S—(3-C₆H₄)—, -6-(C₆H₃N₂S), -6-(2-C₇H₃NS)—S—NRR′ where RR′ is —CH₂CH₂OCH₂CH₂—, —(4-C₆H₄)—S—S—S—S—(4-C₆H₄)—, —(4-C₆H₄)—CH═CH₂, —(4-C₆H₄)—S—SO₃H, —(4-C₆H₄)—SO₂NH—(4-C₆H₄)—S—S—(4-C₆H₄)—NHSO₂—(4-C₆H₄)—, -6-(2-C₇H₃NS)—S—S-2-(6-C₇H₃NS)—, —(4-C₆H₄)—S—CH₂—(4-C₆H₄)—, —(4-C₆H₄)—SO₂—S—(4-C₆H₄)—, —(4-C₆H₄)—CH₂—S—CH₂—(4-C₆H₄)—, —(3-C₆H₄)—CH₂—S—CH₂—(3-C₆H₄)—, —(4-C₆H₄)—CH₂—S—S—CH₂—(4-C₆H₄)—, —(3-C₆H₄)—CH₂—S—S—CH₂—(3-C₆H₄)—, —(4-C₆H₄)—S—NRR′, where RR′ is —CH₂CH₂OCH₂CH₂—, —(4-C₆H₄)—SO₂NH—CH₂CH₂—S—S—CH₂CH₂—NHSO₂—(4-C₆H₄)—, —(4-C₆H₄)-2-(1,3-dithianyl), and —(4-C₆H₄)—S—(1,4-piperizinediyl)—S—(4-C6H4)—.

Another set of organic groups which may be attached to the carbonaceous material are organic groups having an aminophenyl, such as (C₆H₄)—NH₂, (C₆H₄)—CH₂—(C₆H₄)—NH₂, (C₆H₄)—SO₂—(C₆H₄)—NH₂.

Preferably, the organic group is a C₁-C₁₀₀ alkyl group (more preferably a C₁-C₁₂ alkyl group), an aromatic group, or other organic group, monomeric group, or polymeric group, each optionally having a functional group or ionic or ionizable group. More preferably, these groups are directly attached to the carbonaceous material.

The polymeric group can be any polymeric group capable of being attached to a carbon product. The polymeric group can be a polyolefin group, a polystyrenic group, a polyacrylate group, a polyamide group, a polyester group, or mixtures thereof. Monomeric groups are monomeric versions of the polymeric groups.

The organic group can also be an olefin group, a styrenic group, an acrylate group, an amide group, an ester, or mixtures thereof. The organic group can also be an aromatic group or an alkyl group, either group with an olefin group, a styrenic group, an acrylate group, an amide group, an ester group, or mixtures thereof, wherein preferably the aromatic group, or the alkyl group, like a C₁-C₁₂ group, is directly attached to the carbon product.

The polymeric group can include an aromatic group or an alkyl group, like a C₁-C₁₂ group, either group with a polyolefin group, a polystyrenic group, a polyacrylate group, a polyamide group, an polyester group, or mixtures thereof.

The organic group can also comprise an aralkyl group or alkylaryl group, which is preferably directly attached to the carbon product. Other examples of organic groups include a C₁-C₁₀₀ alkyl group, and more preferably a C₂₀-C₆₀ alkyl group.

Examples of other organic groups are organic groups having the following formulas (hyphens on one or more ends represents an attachment to a carbon product or to another group):

—Ar—CO₂(CₘH₂ₘ₊₁), where m=0 to about 20;

—Ar—(CₙH₂ₙ₊₁) where n+1 to about 50;

—Ar—CₚH₂ₚAr—, where p=1 to about 10;

—Ar—CX₃, where X is a halogen atom;

—Ar—O—CX₃, where X is a halogen atom;

—Ar—SO₃⁻;

—Ar—SO₂(C_{q}H_{2q-1}), where q=about 2 to about 10;

—Ar—S₂—Ar—NH₂;

—Ar—S₂—Ar—;

—ArSO₂H;

—Ar—((CₙH₂ₙ)COOX)ₘ, where n=0 to 20, m=1 to 3, and X=H, cations, or organic group; These groups are further activated and/or reacted with such groups as carbodiimides and further reacted with NH₂-terminated functionalization groups; SOCl₂, or PCl₃, or PCl₅ to be converted to —Ar—(CₙH₂ₙ)COCl)ₘ groups and further reacted with OH-terminated functionalization groups.

—Ar—((CₙH₂ₙ)OH)ₘ, where n=0 to 20, m=1 to 3; These groups are further activated and/or reacted with such groups as tosyl chloride and subsequently reacted with amino-terminated ligands; carbonyldiimidazole and subsequently reacted with amino-terminated ligands; carbonylchloride terminated ligands; and epoxy terminated ligands.

—Ar—((CₙH₂ₙ)NH₂)ₘ, where n=0 to 20, m=1 to 3, and its protonated form: —Ar—((CₙH₂ₙ)NH₃X)ₘ, where X is an ion; These groups are further activated and/or reacted with such groups as carbodiimide activated carboxyl-terminated ligands; carbonyldiimidazole activated hydroxy-terminated ligands; tosyl activated hydroxy-terminated ligands; vinyl terminated ligands; alkylhalide terminated ligands; or epoxy terminated ligands.

—Ar—((CₙH₂ₙ)CHNH₃⁺COO⁻)ₘ where n=0 to 20 and m=1 to 3; These groups are derivatized further by reaction through the carboxylic group by reaction with NH₂ or OH terminated groups or through the amino group by reaction with activated carboxy-terminated ligands, activated hydroxy-terminated ligands, vinyl ligands, alkylhalide terminated ligands, or epoxy terminated ligands.

—Ar—((CₙH₂ₙ)CH═CH₂)ₘ, where n=0 to 20, m=1 to 3 or —Ar—((CₙH₂ₙ)SO₂CH═CH₂)ₘ, where n=0 to 20, m=1 to 3. These groups are further activated and/or reacted with such groups as amino-terminated ligands; peroxy-acids to form epoxides and subsequently reacted with hydroxy- or amino-terminated ligands; hydrogen halides to form —Ar((CnH₂ₙ)CH₂CH₂X)ₘ groups and subsequently reacted with amino-terminated ligands.

Other reaction schemes can be used to form various groups onto the carbonaceous material.

Preferred mixtures of organic groups include the following:

—Ar—SO₃⁻ and —Ar(CₙH₂ₙ₊₁), where n=1 to about 50;

—Ar—S₂—Ar—NH₂ and —ArCₚH₂ₚAr—, where p=1 to about 10;

—Ar—S₂—Ar— and —ArCₚH₂ₚAr—, where p=1 to about 10; or

at least two different —Ar—CO₂(CₘH₂ₘ₊₁), where m=0 to about 20.

The various organic, monomeric, and polymeric groups described above and below which are part of the modified carbon product can be unsubstituted or substituted and can be branched or linear.

Any one or more of these organic groups, after attachment to the carbonaceous material which permits adsorption, and preferably an increase in the adsorption capacity of the carbonaceous material may be used in the present invention.

Preferably, the organic group attached to the carbonaceous material is an acid or base or a salt of an acid or base, and specific examples include phenyl or naphthyl groups having substituents like sulfonic acid and carboxylic acid. Quaternary ammonium can also be used. Most preferred organic groups attached to the carbonaceous material are (C₆H₄)—SO₃⁻Na⁺, (C₆H₄)—SO₃⁻K⁺, (C₆H₄)—SO₃⁻Li⁺, and the like. Generally, an acid-type organic group attachment will be useful in adsorbing basic adsorbates while a base-type organic group attachment will be useful in adsorbing acidic adsorbates.

Other preferred organic groups which can be used in the present invention include amino acids and derivatized amino acids (e.g., phenyl alanine and its derivatives), cyclodextrins, immobilized proteins and polyproteins, and the like. Other organic groups include, but are not limited to, C₆F₅-groups and/or trifluoromethyl-phenyl groups, and bis-trifluorophenyl groups, other aromatic groups with fluorine groups, and the like. These organic groups are particularly preferred with respect to the embodiments of the present invention relating to chromatography and other separation techniques.

Other preferred organic groups which are attached onto the carbonaceous material include —Ar—(CₙH₂ₙ₊₁)ₓ group functionalities, wherein n is an integer of from about 1 to about 30 and x is an integer of from about 1 to about 3. These groups are particularly preferred for purposes of reverse phase chromatography. Another example of an organic group is benzene with a sulfonic group, benzoic groups, isophtalic groups which are particularly useful for cationic exchanges and quaternary amine groups which are particularly preferred for anionic exchanges.

Organic groups such as cyclodextrins which are directly attached onto the carbonaceous material or attached through an alkyl group such as CₙH₂ₙ₊₁ chain wherein n is an integer of from about 3 to about 20 and also preferred. Other groups that can be attached are optically pure amino acids and derivatized amino acids, immobilized proteins, and the like. These types of organic groups are particularly preferred with respect to chiral chromatography.

In addition, polyethyleneglycol (PEG groups) and methoxy-terminated PEG groups as well as derivatized PEG and MPEG groups can be attached onto the carbonaceous material. These types of organic groups are particularly preferred with respect to affinity and/or hydrophobic interactions chromatography for the separation, for instance, of proteins and polyproteins.

Further examples of organic groups that can be attached, either alone or as an additional group, include —Ar—C(CH₃)₃, —Ar—(CₙH₂ₙ)CN)ₘ, wherein Ar is an aromatic group, n is 0 to 20, and m is 1 to 3; —Ar—((CₙH₂ₙ)C(O)N(H)—CₓH₂ₓ₊₁)ₘ, wherein Ar is an aromatic group, n is 0 to 20, x is 0 to 20 and m is 1 to 3; —Ar—((CₙH₂ₙ)N(H)C(O)—CₓH₂ₓ₊₁)ₘ, wherein Ar is an aromatic group, n is 0 to 20, x is 0 to 20 and m is 1 to 3; —Ar—((CₙH₂ₙ)O—C(O)—N(H)—CₓH₂ₓ₊₁)ₘ, wherein Ar is an aromatic group, n is 0 to 20, x is 0 to 20 and m is 1 to 3; —Ar—((CₙH₂ₙ)C(O)N(H)—R)ₘ, wherein Ar is an aromatic group, n is 0 to 20, x is 0 to 20 and m is 1 to 3, and R is an organic group; —Ar—((CₙH₂ₙ)N(H)C(O)—R)ₘ, wherein Ar is an aromatic group, n is 0 to 20, x is 0 to 20 and m is 1 to 3, and R is an organic group; —Ar—((CₙH₂ₙ)O—C(O)N(H)—R)ₘ, wherein Ar is an aromatic group, n is 0 to 20, x is 0 to 20 and m is 1 to 3, and R is an organic group.

In addition, the present invention has the ability to attach organic groups such that the organic groups block out microporosity of the carbonaceous material and thus permits the use of microporous materials for separation techniques, such as chromatography.

Accordingly, the present invention permits the use of microporous materials that would otherwise not be chromatographically useful for separations.

In the present invention, more than one type of group can be attached onto the carbonaceous material. This is especially useful to fill in any gaps on the surface of the carbonaceous material not having an attached organic group. The filling in of such gaps promotes better selectivity and/or blocks any microporosity that may still exist in the carbonaceous material. Typically, the optional second organic group is attached after the first primary organic group is attached and the modified carbonaceous material is preferably purified as described above by removing any by-products that are produced from attaching an organic group onto the carbonaceous material. Afterwards, the second organic group can then be attached using the same diazonium salt or other attachment methods. Typically, the type of secondary organic groups which are subsequently attached include, but are not limited to, organic groups which are shorter in chain length or have less steric hindrance than the first organic group attached. For instance, preferred secondary organic groups include, but are not limited to, phenyl groups, alkyl phenyl groups having short alkyl chains (e.g., C₁-C₁₅), and the like. Particularly preferred groups include, phenyl, methyl-phenyl, 3,5-dimethyl-phenyl, 4-isopropyl-phenyl, and 4-tert-butyl-phenyl.

The modified carbonaceous materials of the present invention, especially when the attached organic groups are alkyl phenyl groups, like 4-alkyl-phenyl, where the length of the alkyl chain is between 1 and 30, (preferably between 8 or 18), are especially useful for reverse phase chromatography applications having surface properties directly analogous to octadecyl-modified silica. Additionally, the modified carbonaceous materials described above, can have secondary attached groups such as phenyl, methyl-phenyl, dimethyl-phenyl, isopropyl-phenyl, tert-butyl-phenyl, and the like. The carbonaceous materials of the present invention will have one or more of the following properties compared to the conventional octadecyl silica:

Enhanced pH stability (octadecyl silica is only used in a narrow pH and rarely above pH 8). The enhanced carbonaceous materials of the present invention will be stable at all pH.

Enhanced temperature stability. These materials can be used at temperatures up to 250° C., preferably up to 200° C. without significant degradation in performance.

Enhanced resistance to swelling.

Efficiency of separation comparable to silica and much greater than that of polymeric chromatographic materials.

The ability to dial-in the surface properties by determining the concentration of active and endcapping groups on the surface, which would give the stationary phase different selectivities.

A combination of different organic groups is possible. For instance, it is within the bounds of the present invention to attach more than one type of organic group to the same carbonaceous material or use a combination of carbonaceous materials, wherein some of the carbonaceous material has been modified with one organic group and another portion of the carbonaceous material has been modified with a different organic group. Varying degrees of modification are also possible, such as low weight percent or surface area modification, or a high weight percent or surface area modification. Also, mixtures of modified carbonaceous material and unmodified carbonaceous material can be used. Mixtures of modified carbonaceous material with different functionalizations and/or different levels of treatment can be used.

Preferably, the modified carbonaceous materials of the present invention, especially when the attached organic group is a phenyl or naphthyl group having substituents like sulfonic acid, carboxylic acid, or quaternary ammonium or salts thereof, can be directly analogous to polymeric ion exchange resins. These types of carbonaceous materials of the present invention can have one or more of the following properties as compared to conventional polymeric ion exchangers:

a) higher temperature stability;

b) greater resistance to swelling; and

c) greater mechanical strength without adversely affecting uptake kinetics.

Furthermore, the modified carbonaceous materials of the present invention, besides being used as adsorbents, can also be used in separations ranging from water treatment to metals separation/recovery, ion exchange, catalysis, and the like. An additional advantage of an adsorbent possessing exchangeable groups as described above is that it confers on the material the ability to be further surface modified using ion exchange procedures.

With respect to the adsorbates, any adsorbate capable of being adsorbed by one or more of the modified carbonaceous materials of the present invention is contemplated to be within the bounds of the present invention. Examples include, but are not limited to, polar species such as water, ammonia, mercaptans, sulfur dioxide, and hydrogen sulfide. By “polar species,” it is understood that this is a species whose electronic structure is not symmetrical. This includes molecules that possess dipole moments, for example H₂O and NH₃; and/or molecules that possess quadrupole moments, such as CO₂ and molecules that possess unsaturated pi bonds (π), such as alkenes, alkynes, and other organic and inorganic compounds with double and triple bonds. Non-polar species such as argon, oxygen, methane, and the like can also be adsorbed with the appropriate modified carbonaceous materials of the present invention. In view of the description provided in this application, those skilled in the art will be able to determine which organic groups need to be attached to the carbonaceous materials in order to achieve the most effective adsorption affinity or increase in adsorption, depending upon the adsorbate and the adsorption processes involved.

By developing an adsorbent composition containing a modified carbonaceous material capable of adsorbing an adsorbate, selectivity for a particular adsorbate can be enhanced. Using the proper modified carbonaceous material, one can selectively adsorb particular species from a multicomponent mixture. In other words, modifying the carbonaceous material to create the adsorbent composition of the present invention can decrease adsorption affinity for one component in order to maximize the adsorption affinity of another component which will maximize separation of the second component from the first component. Furthermore, by increasing adsorption of polar species, this further results in the relatively decreased adsorption of nonpolar species which improves selectivity. Further, the carbonaceous material can be modified in such a manner as to add a hydrophobic group to “disable” the oxygen functionalities on the surface of the carbonaceous material to increase the selectivity for the adsorption of nonpolar species.

The adsorbate can be in a liquid phase or in the gaseous or vapor phase, depending upon the needs and desires of the user. Certain adsorbates can be more efficiently adsorbed from the vapor or gaseous phases than from the liquid phase or vice versa, and the modified carbonaceous materials of the present invention are effective in adsorption from either phase.

One advantage of the present invention is to modify the surface of an activated carbon or carbon black adsorbent extensively, without damaging the structure or making the adsorbent more friable. For instance, a carbonaceous material can be surface modified based on the present invention with exchangeable sodium cations attached to the surface. This is very useful from the point of view of substituting different ions to alter the chemistry of the surface.

The beneficial effect of using the modified carbonaceous materials of the present invention for the purpose of adsorption can be demonstrated by comparing the adsorption isotherms of an adsorbate on an unmodified carbonaceous adsorbent and the same carbonaceous adsorbent modified in accordance with the present invention.

The present invention will be further clarified by the following examples, which are intended to be purely exemplary of the present invention.

### EXAMPLES

The effectiveness of the surface modification of exemplary carbonaceous material was determined by comparing the adsorption isotherms of various adsorbates on the unmodified carbonaceous materials, with adsorption isotherms on the carbonaceous materials modified in accordance with the present invention. Adsorbates used were water and CO₂, but other adsorbates could also be used.

### Example 1

Pellets of Black Pearls® 430 carbon black and Darco S51 activated carbon from Norit were surface-modified using the following procedure:

Surface Modification of Black Pearls® 430 Carbon Black:

A dispersion of 5 ml of water dilutable phenol-formaldehyde thermosetting resin (Schenectady International, Schenectady, N.Y.) in 50 mL of water was mixed with 50 g of Black Pearls® 430 carbon black (available from Cabot Corp., Boston, Mass.). The mixture was pressed in 1 g portions using a 0.25 inch stainless steel die at a pressure of 5000 psi. The pellets were heated under flowing argon at 110° C. for one hour and at 135° C. for one hour to cure the resin. The temperature was then raised under flowing argon at 20° C./min until a temperature of 650° C. was reached. The temperature was then held at 650° C. for three hours and cooled under flowing argon. The pellets were then crushed into pieces about 1 mm by 2 mm.

An aqueous solution of 0.81 g of sodium nitrite in about 1 g of water was added to a mixture of 16.8 g of the carbon black granules, 2.04 g of sulfanilic acid, and 50 g of water that was stirring at 84° C. After stirring for two hours, the resulting material was dried in an oven at 65° C.

Surface Modification of Activated Carbon:

An aqueous solution of 30.5 g of sodium nitrite in about 100 g of water was added to a boiling mixture of 130 g of DARCO S51 activated carbon (available from Norit), 76.5 g of sulfanilic acid, and 1300 g of water. After stirring for 15 minutes, the heating was discontinued and the mixture was allowed to cool to room temperature with stirring. The resulting material was dried overnight in an oven at 50° C.

Ion Exchange:

The surface modified carbons were washed with a large amount of deionized water and dried. The material thus obtained was in the sodium form. Further modification of the carbon into potassium and lithium forms was carried out by ion exchange using 2M solutions of KOH and LiOH, respectively. The ion-exchanged material was washed thoroughly and dried. Adsorption experiments were carried out on the washed, dried materials.

The surface areas of the unmodified and surface modified carbon materials are shown in Table 1 below. Surface areas were calculated from nitrogen (77 K) adsorption data using the BET formalism (S. J. Gregg and K. S. W. Sing, in Adsorption, Surface Area, and Porosity,” Academic Press, 1982). The adsorption experiments were carried out on an ASAP 2000 automated instrument, manufactured by Micromeritics Corp.

TABLE 1
Surface Areas and Pore Volumes of
Unmodified and Surface Modified Materials

| | BET Surface | Pore Volume, |
|---|---|---|
| Sample ID | Area, m²/g | cm³/g |
| BP 430 pellets, unmodified | 99 | 0.518 |
| BP 430, modified, washed | 92 | 0.49 |
| Darco S51 | 694 | 0.809 |
| Darco S51, modified, washed | 141.3 | 0.279 |

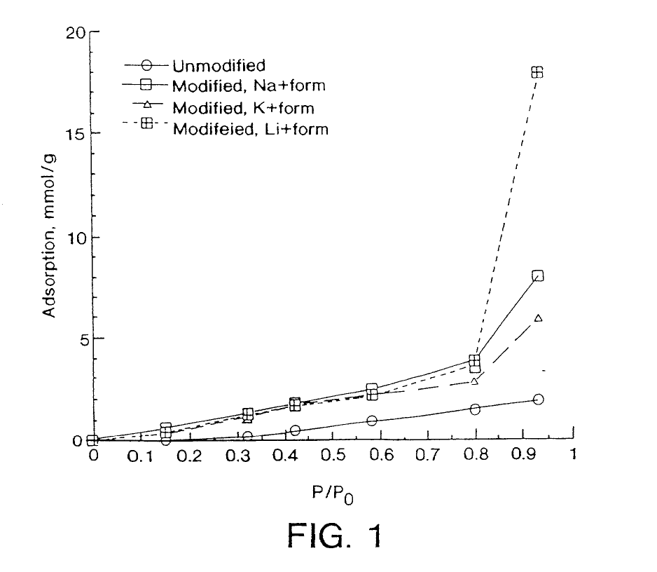

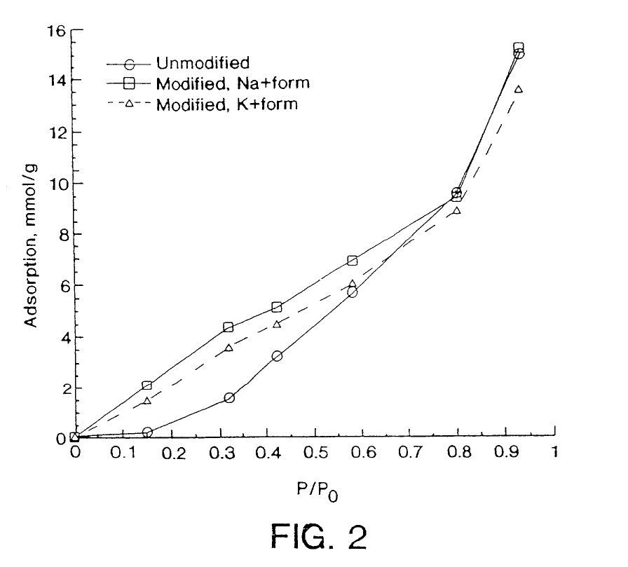

While the activated carbon lost some surface area and pore volume after the surface modification treatment, both the carbon black and the activated carbon underwent an increase in adsorption capacity per unit surface area as a result of the surface modification. The loss of any surface area and pore volume may be mitigated by pre-treating the carbonaceous material with immiscible organic solvent, like heptane. The results from adsorption of water vapor at 298 K on the unmodified and modified material are shown in FIG. 1 (carbon black) and FIG. 2 (activated carbon). The water adsorption experiments were carried out by a batch technique that involved equilibrating the sample with water vapor at a constant relative humidity, in a sealed cell. The constant relative humidities were attained by using saturated salt solutions, which have known relative humidities above their surface.

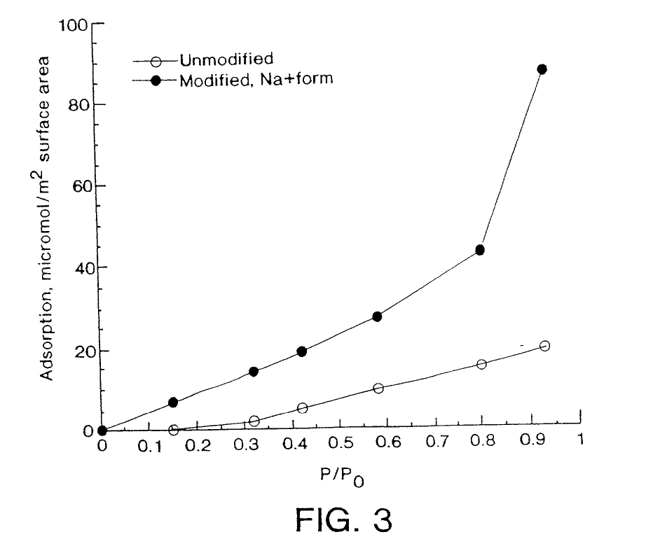

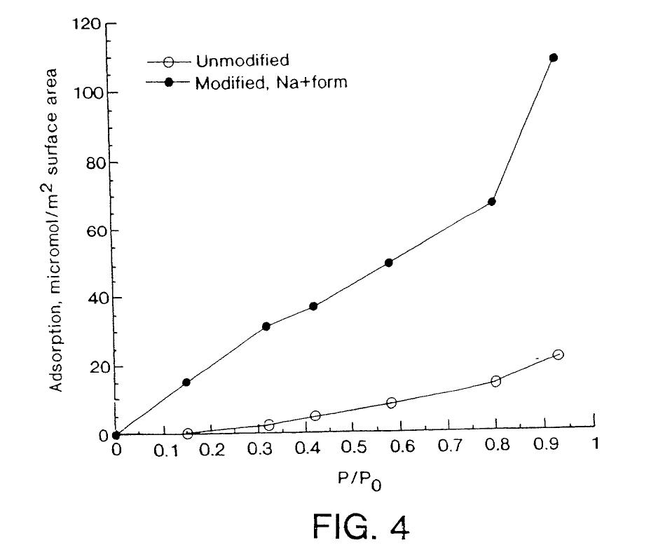

Both the activated carbon and carbon black contained Na⁺ ions on the surface after the surface modification was carried out. The Na⁺ ions can be substituted by other ions using standard ion exchange procedures (e.g., see Ion Exchange, by F. Helfferich, McGraw-Hill, 1962). The water adsorption isotherms for the surface-modified material with Na ions on the surface, as well as the other ionic forms derived by ion exchange, are shown in FIGS. 1 and 2. The adsorption isotherms show the quantity of water vapor adsorbed, per gram of adsorbent, as a function of the relative pressure of water vapor. FIGS. 3 and 4 show the same data normalized by the BET surface area of the materials. It is clear that the adsorption capacities per unit area of the carbon black, Black Pearls® 430 carbon black and the Darco S51 carbon black, are considerably enhanced by the surface modification described in this invention. In addition, the shape of the water adsorption isotherm is changed as a result of the surface modification (concave upward, to linear or convex upward).

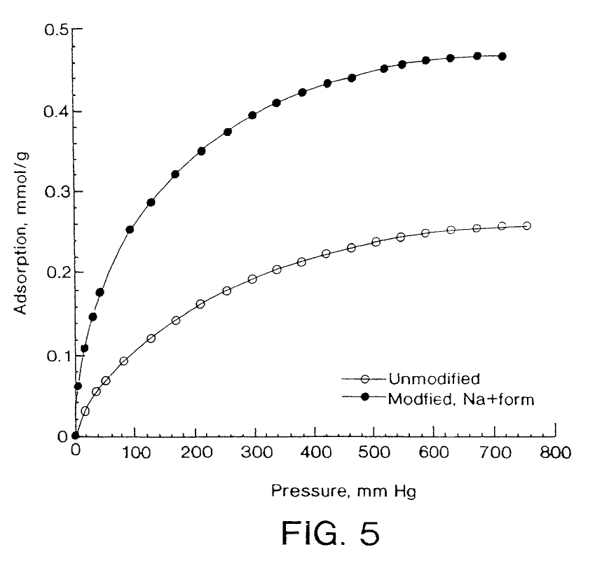

The surface modification technique of the present invention may affect the adsorption of gases like CO₂ as well, which possesses a quadrupole movement. FIG. 5 shows the adsorption isotherm of CO₂ from the gas phase at 273 K on the same unmodified and modified Black Pearls® 430 carbon black. Adsorption of CO₂ was carried out on an ASAP 2000 automated adsorption system manufactured by Micromeritics Corp. The figure shows the quantity of CO₂ adsorbed as a function of the CO₂ pressure. Clearly, the adsorption of CO₂ is enhanced by the carbon surface modification technique described in this invention.

### Example 2

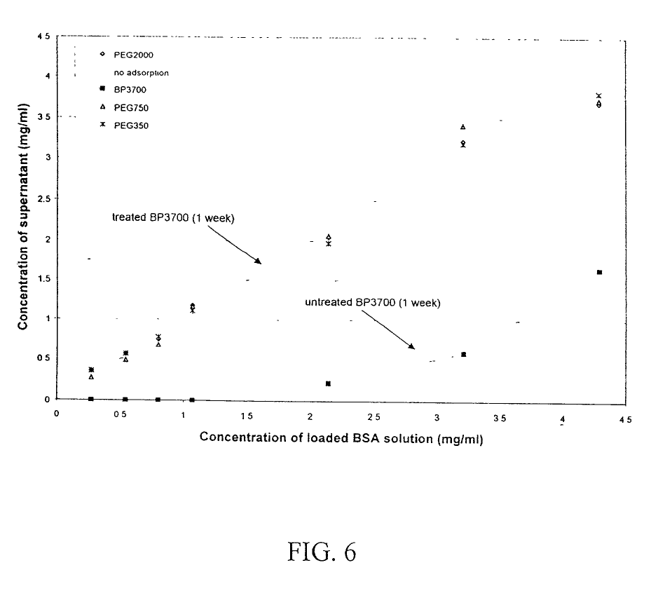

The use of carbonaceous material for chromatographic and other biochemical applications involving contact with proteins has traditionally been hindered by the non-specific adsorption of proteins at the carbon surface. Using various types of conventional carbonaceous materials as well as carbonaceous materials of the present invention, several experiments were conducted to determine the non-specific adsorption of proteins at the carbon surface by these various carbonaceous materials including carbonaceous materials of the present invention. Black Pearls® 3700, available from Cabot Corporation, was chemically modified by attaching methoxy terminated polyethylene glycol groups onto the carbon black with the use of the diazonium reaction described above. The polyethylene groups attached had average molecular weights of 350, 750, and 2000. The modified carbon blacks were dispersed in water during their preparation and subsequently purified by 10 volumes of diafiltration for removal of impurities and reaction byproducts. A stock solution of 10 mg/ml of Bovine Serum Albumin (BSA) was prepared and used for all the experiments detailed below. Appropriate amounts of dispersion containing 0.5 g of each modified carbon black and 0.5 g of unmodified BP3700 were introduced in separate 20 ml vials. In each vial, protein solution and deionized water were introduced so that the total final weight of the contents of each vial was approximately 7.5 g, with approximately 7 ml of liquid. Protein solutions varied in concentrations between 0 and 4.5 mg/ml. The vials were vortexed for 2 hours to intimately mix the protein solution with the carbon black particles. After 1 week, the vials were vortexed again, and subsequently 2 ml aliquots were taken and centrifuged at 11,000 RPM for the time required to separate the carbon black particles. The protein concentrations in the supernatant solutions were measured using the standard Bradford assay. The protein concentrations were measured using the standard Bradford Assay as described in Analytical Biochemistry, 72, pp. 248-254 (1976), which is incorporated in its entirety by reference herein. As a comparison, Black Pearl® 3700 which was not modified was used as a control. The remaining concentration of BSA in the aqueous solution was measured after 1 week and the amount of BSA adsorbed by the various carbonaceous materials in the separate experiments was plotted. As can be seen in FIG. 6, the modified carbonaceous material of the present invention was quite successful in not adsorbing the protein since the diagonal line in FIG. 6 represents no adsorption and as can be seen, the chemically modified carbonaceous materials of the present invention were quite successful in not adsorbing significant amounts of proteins on the surface. However, the untreated or conventional carbon black adsorbs significant amounts of the BSA on the carbon surface. Thus, the present invention, through the use of organic groups on a carbonaceous material can be quite successful in promoting non-specific adsorption of protein at the carbon surface. The conventional carbon black adsorbed approximately 0.9 mg/m² of BSA from a solution after one week while the concentration of BSA in the aqueous solution did not change in the presence of the carbonaceous materials of the present invention.

### Example 3

Preparation of Octadecylphenyl Surface Modified Carbon-clad Zirconia Particles (SP-1)

15 g of deionized water and 15 g of ethanol, 0.83 g of 4-octadecylaniline and 1.01 g of a 30 wt % nitric acid solution were mixed in a beaker and heated to 50° C. 10 g of ZirChrom-Carb particles (provided by ZirChrom Separations, Anoka, Minn.) were added to the mixture and the temperature was increased to 60° C. 0.83 g of a 20 wt % solution of sodium nitrite were added dropwise over 2 minutes. The mixture was left to react at 60° C. for 1.5 hours. After the reaction was complete, the reaction mixture was left to cool to room temperature and filtered using Whatman 1 filter paper. The particles were rinsed with ethanol, tetrahydrofuran (THF), and a 1 wt % NaOH solution and then soxhlet extracted for 16 hours in ethanol and 12 hours in THF. The particles SP-1 were subsequently left to dry. The starting particles ZirChrom-Carb particles had 1.18 wt % C and the final SP-1 particles had 3.4 wt %C, indicating surface coverage with octadecylphenyl groups.

Endcapping of Octadecylphenyl Surface Modified Carbon-clad Zirconia Particles with T-butylphenyl Groups (SP-2)

The particles SP-1 prepared in the previous step were mixed in a beaker with 22.5 g of deionized water, 7.5 g of ethanol, 0.22 g of 4-tert-butylaniline, and 0.63 g of a 30 wt % nitric acid solution and heated to 60° C. 0.52 g of a 20 wt % solution of sodium nitrite were added dropwise over 2 minutes. The mixture was left to react at 60° C. for 1.5 hours. After the reaction was complete, the reaction mixture was left to cool to room temperature and filtered using Whatman 1 filter paper. The particles were rinsed with ethanol, THF, and 1 wt % NaOH solution and extracted in ethanol for 16 hours and THF for 8 hours. The particles SP-2 were subsequently left to dry. The final particles had 3.72 wt %C indicating that tert-butylphenyl groups were attached to the surface.

The particles SP-2 were then slurry packed into a 50×4.6 mm HPLC column used in the subsequent examples of chromatographic separations.

### Example 4

Separation Efficiency for 22 Solutes

In order to demonstrate the chromatographic use of particles SP-2, the retention times of 22 solutes were measured. The solutes were injected in 5 μl volumes into a mobile phase consisting of 40 vol % acetonitrile and 60 vol % water held at 30° C. and flowing at 1 ml/min. Table 2 contains the retention factors k′ for these solutes for a column packed with the unmodified ZirChrom-Carb particles and for a column packed with particles SP-2. These retention factors were measured using a UV detector at 254 nm. Each solute has a different retention factor, which means that if a mixture of these solutes was injected into the column, they would elute at different times, enabling their separation. The effect of surface modification is seen in Table 2. The retention factors of all compounds in the column packed with SP-2 particles are different from those in the column packed with the unmodified ZirChrom-Carb particles. This indicates that a unique and different chromatographic selectivity was accomplished by surface modification.

TABLE 2
Retention factors (k′) for 22 solutes obtained with
a column packed with particles SP-2 compared to those
of unmodified ZirChrom-Carb particles.

| | k′ | |
|---|---|---|
| | ZirChrom- | k′ (SP-2) |
| Solute | Carb | C18/t-butyl |
| N-benzylformamide | 0.49 | 0.222 |
| Benzylalcohol | 0.54 | 0.286 |
| Phenol | 0.59 | 0.236 |
| 3-phenylpropanol | 1.19 | 0.488 |
| p-chlorophenol | 2.49 | 0.841 |
| Acetophenone | 2.06 | 1.057 |
| Benzonitrile | 1.55 | 1.012 |
| Nitrobenzene | 4.76 | 2.078 |
| Methylbenzoate | 3.75 | 1.884 |
| Anisole | 1.57 | 1.680 |
| Benzene | 0.76 | 1.454 |
| p-chlorotoluene | 5.79 | 6.919 |
| p-nitrobenzyl chloride | 13.90 | 4.604 |
| Toluene | 1.70 | 2.793 |
| Benzophenone | 16.91 | 6.512 |
| Bromobenzene | 3.57 | 5.097 |
| Napthalene | 39.48 | 18.046 |
| Ethylbenzene | 2.36 | 4.526 |
| p-xylene | 3.85 | 6.081 |
| p-dichlorobenzene | 8.50 | 10.159 |
| Propylbenzene | 4.73 | 8.332 |
| Butylbenzene | 9.12 | 15.393 |

### Example 5

Preparation of Dodecylphenyl Surface Modified Carbon-clad Zirconia Particles (SP-3) and T-butylphenyl Endcapped Dodecylphenyl Surface Modified Carbon-clad Zirconia Particles (SP-4)

Dodecylphenyl surface modified carbon-clad zirconia particles (SP-3) were prepared using a similar procedure to that described in Example 3 for the preparation of particles SP-1, using equivalent molar amounts of 4-dodecylaniline instead of 4-octadecylaniline as the treating reagent. t-butyl phenyl endcapped dodecylphenyl surface modified carbon-clad zirconia particles (SP-4) were also prepared starting from particles SP-3, using a procedure similar to that described in Example 3 for the preparation of particles SP-2 from particles SP-1.

### Example 6

Effect of Endcapping on the Separation of Pharmaceutical Molecules

The retention of basic pharmaceutical molecules lidocaine, atenolol, and labetalol was measured using HPLC columns packed with ZirChrom-Carb, particles SP-2, SP-3, and SP-4. The solutes were injected in 5 μl volumes into a mobile phase consisting of 80 vol % acetonitrile and 20 vol % 20 mM potassium phosphate buffer at pH 10, held at 30° C. and flowing at 1 ml/min. The retention factors are compared in Table 3. One observes that atenolol and labetalol are very strongly retained on the starting ZirChrom-Carb HPLC column, because their retention factors are greater than 30. Surface modification simply with a dodecylphenyl group (particles SP-3) decreases the retention factor for lidocaine, but does not effect the retention of atenolol and labetalol. It is only after endcapping with t-butylphenyl groups (particles SP-4 and SP-2) that the retention of atenolol and labetalol is significantly reduced. This reduction in retention indicates that adding the smaller t-butylphenyl groups helps improve the chromatographic performance by blocking access to the sites on the carbon surface responsible for the strong retention of these basic pharmaceutical molecules.

TABLE 3
Comparison of retention factors for basic pharmaceutical
molecules on various HPLC columns packed with
surface modified carbon-clad zirconia particles.

| | k′ | | | |
|---|---|---|---|---|
| | ZirChrom- | k′ (SP-3) | k′ (SP-4) | k′ (SP-2) |
| Solute | Carb | C12 | C12/t-butyl | C18/t-butyl |
| Lidocaine | 19.07 | 2.33 | 2.52 | 5.35 |
| Atenolol | >30 | >30 | 1.70 | 10.12 |
| Labetalol | >30 | >30 | 2.03 | 9.53 |

### Example 7

Separation of Barbiturates

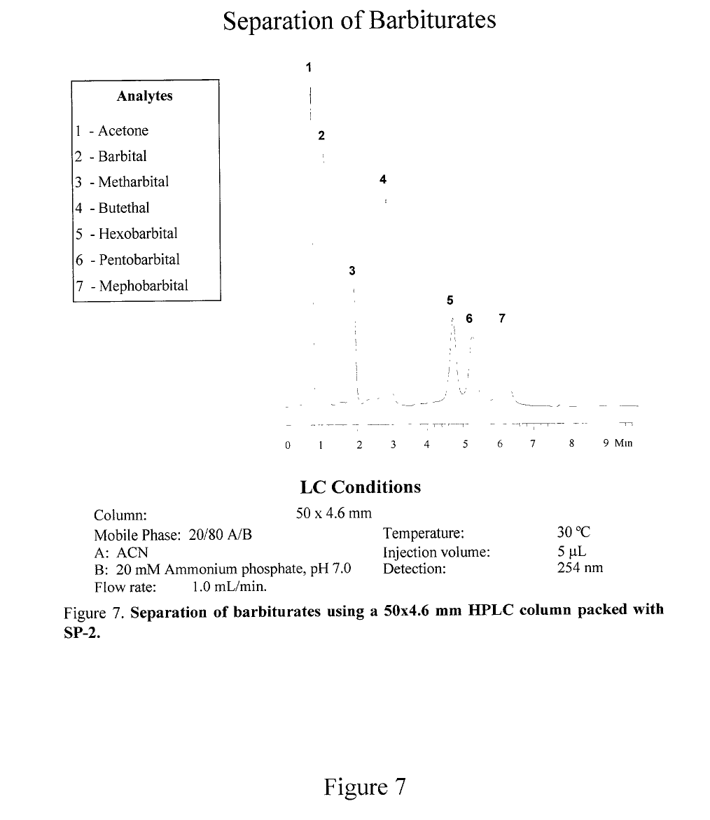

A 5 μl mixture of acetone, barbital, metharbital, butethal, hexobarbital, pentobarbital, and mephobarbital was introduced in a mobile phase consisting of 80 vol % acetonitrile, 20 vol % 20 mM Ammonium phosphate buffer at pH 7.0, flowing at 1 ml/min at 30° C. The separation of analytes by an HPLC column packed with particles SP-2 is shown in FIG. 7. The analytes were detected by UV absorption at 254 nm.

### Example 8

The Effect of Temperature on the Separation of PTH-aminoacids

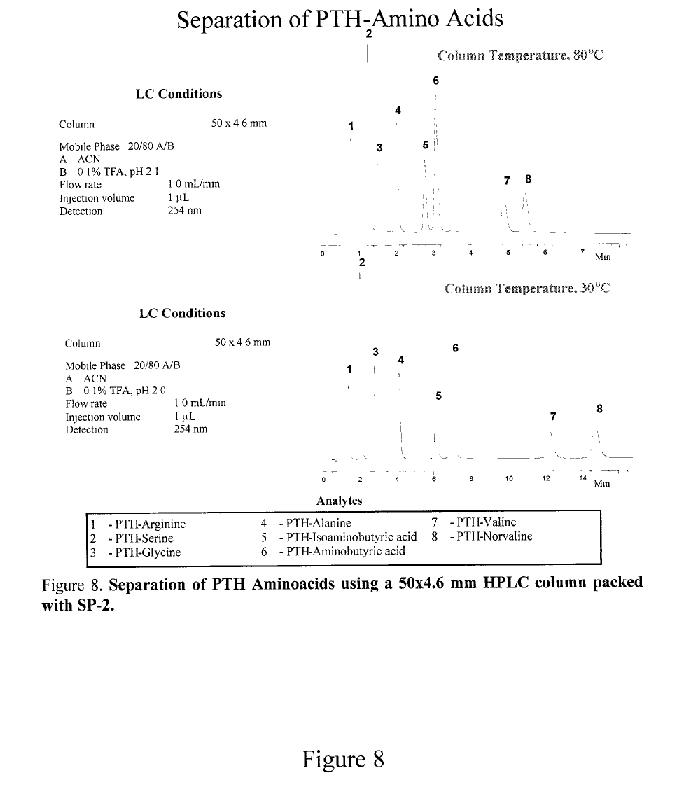

In this example the effect of temperature on the separation of 3-phenyl-2-thiohydantoin (PTH) derivatized aminoacids is used to illustrate the advantages of performing chromatographic separations at higher temperatures using the column containing particles SP-2. A 1 μl mixture of PTH derivatives of arginine, serine, glycine, alanine, isoaminobutyric acid, aminobutyric acid, valine, and norvaline was injected into a mobile phase consisting of 20 vol % Acetonitrile and 80 vol % of a 0.1% trifluoroacetic acid solution at pH 2.0 with a flow rate of 1 ml/min. The separation is shown at 30° C. and 80° C. in FIG. 8. Increasing the temperature by 50° C. reduces the separation time from greater than 14 minutes to less than 6 minutes, effectively halving the analysis time.

### Example 9

Separation of Nonsteroidal Antiinflammatory Drugs

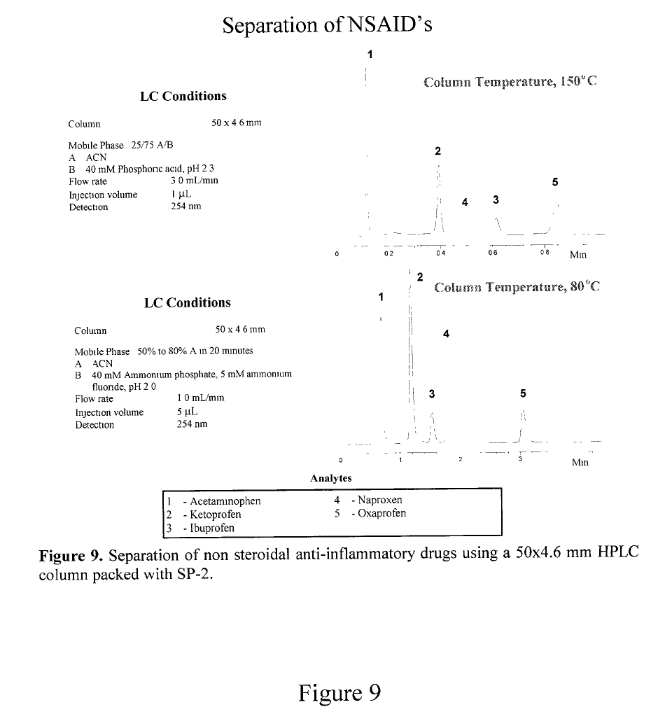

The effect of temperature on the speed of chromatographic separations using the packing material SP-2 is also illustrated on this example of the separation of a mixture of acetaminophen, ketoprofen, ibuprofen, naproxen, and oxaprofen at 80 and 150° C., which is shown in FIG. 9. At 80° C., an injection volume of 5 μl was used in combination with a gradient elution, with the mobile phase flowing at 1 ml/min and the composition transitioning over 20 minutes from 50 vol % to 80 vol % acetonitrile, and 50 vol % to 20 vol % 40 mM ammonium phosphate, 5 mM ammonium at pH 2. At a temperature of 150° C. an injection volume of 1 μl was used with a mobile phase consisting of 75 vol % acetonitrile, and 25 vol % 40 mM phosphoric acid at pH 2.3 and a flow rate of 3.0 ml/min. The separation time dropped from approximately 3 minutes at 80° C. to less than 1 minute at 150° C.

Example 10

Separation of Ethylbenzene and P-xylene

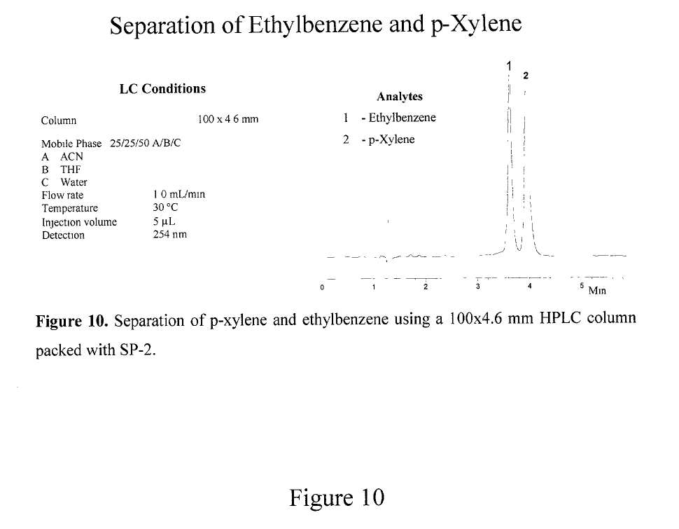

The separation of these two molecules is very difficult using traditional silica based stationary phases. However, as is shown in FIG. 10, a column packed with stationary phase SP-2 is capable of separating the mixture. An injection volume of 5 μl is used with a mobile phase consisting of 25 vol % acetonitrile, 25 vol % tetrahydrofuran, and 50 vol % water at 30° C. and a flowrate of 1 ml/min.

### Example 11

Separation of Beta-blockers

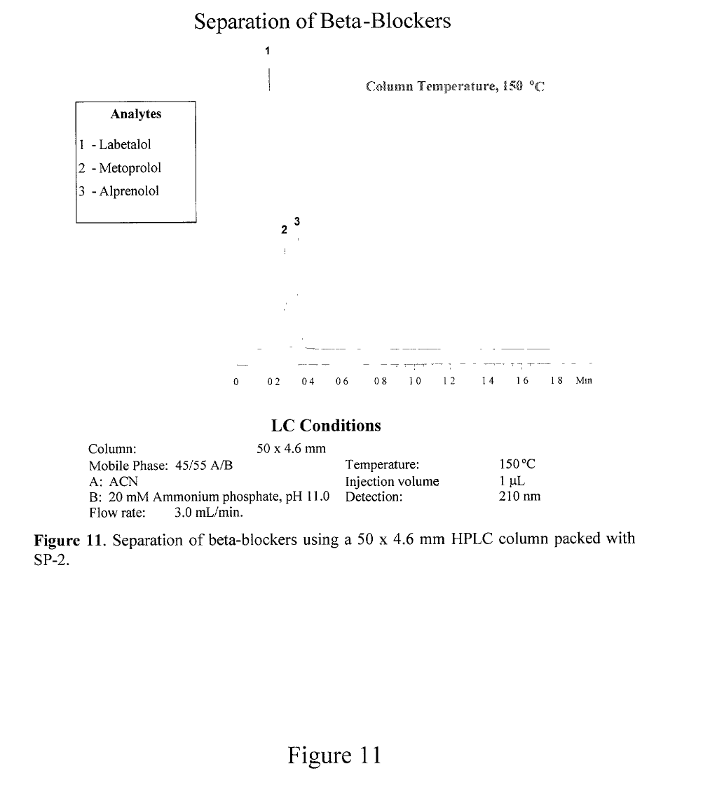

A column packed with SP-2 was used to separate a mixture of beta-blockers consisting of labetalol, metoprolol, and alprenolol. A 1 μl sample was injected into a mobile phase consisting of 45 vol % ACN and 55 vol % 20 mM ammonium phosphate at pH 11. The mobile phase was heated to 150° C. and flowing at a rate of 3 ml/min. The detection was by UV at 210 nm. As is shown in FIG. 11 the separation was accomplished in less than 0.5 min.

### Example 12

Preparation of Benzenesulfonic Acid Surface Modified Carbon clad Zirconia Particles

11 g of deionized water and 4 g of ethanol, 0.17 g (1 mmol) of sulfanilic acid and 0.21 g of a 30 wt % nitric acid solution (1 mmol) were mixed in a beaker and heated to 50° C. 5 g of ZirChrom-Carb particles were added to the mixture and the temperature was raised to 65° C. 0.35 g of a 20 wt % solution of sodium nitrite (1 mmol) were added dropwise over 2 minutes. The mixture was left to react at 65° C. for 1.5 hours. After the reaction was complete, the reaction mixture was left to cool to room temperature and filtered using Whatman 1 filter paper. The particles were rinsed with deionized water, ethanol, methanol, and a 1 wt % NaOH solution and then extracted using the Dionex ASE-300 extractor with water, and a 50/50 ethanol-water mixture. The particles SP-5 were subsequently left to dry. The starting particles ZirChrom-Carb particles had 0.97 wt % C and the final SP-5 particles had 1.4 wt % C, indicating the attachment of benzenesulfonic groups.

### Example 13

Preparation of Phenyl Ethylamide of Dinitrobenzoyl-L-phenylglycine surface Modified Carbon Clad Zirconia Particles (SP-6)

1.96 grams of dinitrobenzoyl-L-phenyl glycine [2,(4-aminophenyl) ethyl] amide were dissolved in a beaker containing a mixture of 31.5 ml tetrahydrofuran (THF) and 13.5 ml deionized water and heated to 50° C. 15 grams of Zirchrom-Carb were added and mixed for 5 minutes. 0.591 ml of HCl was diluted with 1 ml of water and added to the reaction mixture. 0.256 grams of sodium nitrite was dissolved in 1 ml of water and added drop-wise to the reaction mixture. The reagents were mixed for 2 hours at 50° C. The particles were filtered by vacuum filtration and washed with THF and Ethanol and subsequently extracted for 3 hours with THF. The starting particles ZirChrom-Carb particles had 1.68 wt % C and 0.05 wt % N and the final SP-6 particles had 3.1 wt % C and 0.33 wt %N.

### Example 14

Preparation of Phenylethylamine Surface Modified Carbon Clad Zirconia Particles (SP-7)

45 g of deionized water and 20 g of ethanol, 0.72 g (5.3 mmol) of 4-aminophenethylamine and 1.93 g (10.6 mmol) of a 20 wt % hydrochloric acid solution were mixed in a beaker and heated to 40° C. 22 g of ZirChrom-Carb particles were added to the mixture and the temperature was increased to 60° C. 1.82 g (5.3 mmol) of a 20 wt % solution of sodium nitrite were added dropwise over 2 minutes. The mixture was left to react at 60° C. for 1.5 hours. After the reaction was complete, the reaction mixture was left to cool to room temperature and filtered using Whatman 1 filter paper. The particles were rinsed with ethanol, THF, and a 1 wt % NaOH solution and then soxhlet extracted overnight in ethanol. The particles SP-7 were subsequently left to dry. The starting ZirChrom-Carb particles had 1.03 wt % C and the final SP-7 particles had 2.41 wt %C, indicating surface coverage with phenethylamino groups.

Other embodiments of the present invention will be apparent to those skilled in the art from consideration of the specification and practice of the invention disclosed herein. It is intended that the specification and examples be considered as exemplary only, with a true scope and spirit of the invention being indicated by the following claims and equivalents thereof.

What is claimed is:

1. A chromatography column comprising a column having a stationary phase and a mobile phase, wherein said stationary phase comprises carbonaceous material having attached at least one organic group.

2. The chromatography column of claim 1, wherein said organic group comprises at least one aromatic group directly attached onto the carbonaceous material.

3. The chromatography column of claim 1, wherein said organic group comprises at least one alkyl group directly attached onto the carbonaceous material.

4. The chromatography column of claim 1, further comprising a substance comprising chemical species to be separated in said column.

5. A separation device comprising a mobile phase and a stationary phase, wherein said stationary phase comprises carbonaceous material having attached at least one organic group.

6. A method for conducting separation of chemical species from a substance, wherein said method comprises passing said substance through a system containing a mobile phase and a stationary phase, wherein said stationary phase comprises carbonaceous material having attached at least one organic group.

7. The method of claim 6, wherein said separation is liquid chromatography.

8. The method of claim 6, wherein said separation is size exclusion chromatography.

9. The method of claim 6, wherein said separation is chromatography by affinity wherein the chemical species in the substance have different affinities for the stationary phase.

10. The method of claim 6, wherein said separation is an adsorption-desorption chromatography.

11. The method of claim 6, wherein said separation is electrophoresis or electrochromatography.

12. A method for conducting separation by electrophoresis comprising a stationary phase and a mobile phase located between a positive electrode and a negative electrode, passing a current between said electrodes, and introducing a substance containing different chemical species to be separated, wherein said stationary phase comprises carbonaceous material having attached at least one organic group.

13. A membrane separation system comprising a membrane wherein said membrane comprises carbonaceous material having attached at least one organic group.

14. The membrane separation system of claim 13, wherein said system is a reverse osmosis system.

15. An electrophoresis separation comprising a stationary phase, a mobile phase, and a positive electrode and a negative electrode, wherein said stationary phase comprises carbonaceous material having attached at least one organic group.

16. The separation device of claim 5, wherein the organic group is a phenyl or naphthyl group having ionic or ionizable groups.

17. The separation device of claim 5, wherein the organic group comprises an amino acid or derivatized amino acid, cyclodextrin, immobilized protein, polypeptides, or combinations thereof.

18. The separation device of claim 5, wherein the organic group comprises a —C₆F₅ group, a trifluoromethyl-phenyl group, a bis-trifluorophenyl group, or combinations thereof.

19. The separation device of claim 5, wherein the organic group comprises —Ar—(CₙH₂ₙ₊₁)ₓ group, wherein n is an integer of from about 1 to about 30 and x is an integer of from about 1 to about 3.

20. The separation device of claim 5, wherein the organic group comprises an immobilized protein for the separations of racemic mixtures into their optically pure components.

21. The separation device of claim 5, wherein the organic group comprises polyethylene glycol or methoxy-terminated polyethylene glycol or derivatized resins thereof.

22. The separation device of claim 5, wherein the organic group comprises —Ar—((CₙH₂ₙ)COOX)ₘ, wherein Ar is an aromatic group, n is 0 to 20, m is 1 to 3, and X is H, a cation, or an organic group.

23. The separation device of claim 5, wherein the organic group comprises Ar—((CₙH₂ₙ)OH)ₘ, wherein Ar is an aromatic group, n is 0 to 20, m is 1 to 3.

24. The separation device of claim 5, wherein the organic group comprises —Ar—((CₙH₂ₙ)NH₂)ₘ, wherein n is 0 to 20, m is 1 to 3, or its protonated form: —Ar—((CₙH₂ₙ)NH₃X)ₘ, wherein X is an ion, and Ar is an aromatic group.

25. The separation device of claim 5, wherein the organic group comprises —Ar—((CₙH₂ₙ)CHNH₃⁺COO⁻)ₘ and the reaction products thereof with molecules containing functional groups terminated in —NH₂, —OH, or —COOH, wherein Ar is an aromatic group and n is 0 to 20.

26. The separation device of claim 5, wherein the organic group comprises —Ar—((CₙH₂ₙ)CH═CH₂)ₘ, wherein n is 0 to 20, m is 1 to 3 or —Ar—((CₙH₂ₙ)SO₂CH═CH₂)ₘ, where n is 0 to 20 and m is 1 to 3.

27. The separation device of claim 5, wherein the organic group comprises at least one chiral ligand group.

28. The separation device of claim 16, further comprising a second organic group attached on the carbonaceous material.

29. The separation device of claim 17, further comprising a second organic group attached on the carbonaceous material.

30. The separation device of claim 18, further comprising a second organic group attached on the carbonaceous material.

31. The separation device of claim 19, further comprising a second organic group attached on the carbonaceous material.

32. The separation device of claim 20, further comprising a second organic group attached on the carbonaceous material.

33. The separation device of claim 21, further comprising a second organic group attached on the carbonaceous material.

34. The separation device of claim 22, further comprising a second organic group attached on the carbonaceous material.

35. The separation device of claim 23, further comprising a second organic group attached on the carbonaceous material.

36. The separation device of claim 24, further comprising a second organic group attached on the carbonaceous material.

37. The separation device of claim 25, further comprising a second organic group attached on the carbonaceous material.

38. The separation device of claim 26, further comprising a second organic group attached on the carbonaceous material.

39. The separation device of claim 28, wherein said second organic group has a shorter chain length or less steric hindrance than said organic group.

40. The separation device of claim 29, wherein said second organic group has a shorter chain length or less steric hindrance than said organic group.

41. The separation device of claim 30, wherein said second organic group has a shorter chain length or less steric hindrance than said organic group.

42. The separation device of claim 31, wherein said second organic group has a shorter chain length or less steric hindrance than said organic group.

43. The separation device of claim 32, wherein said second organic group has a shorter chain length or less steric hindrance than said organic group.

44. The separation device of claim 33, wherein said second organic group has a shorter chain length or less steric hindrance than said organic group.

45. The separation device of claim 34, wherein said second organic group has a shorter chain length or less steric hindrance than said organic group.

46. The separation device of claim 35, wherein said second organic group has a shorter chain length or less steric hindrance than said organic group.

47. The separation device of claim 36, wherein said second organic group has a shorter chain length or less steric hindrance than said organic group.

48. The separation device of claim 37, wherein said second organic group has a shorter chain length or less steric hindrance than said organic group.

49. The separation device of claim 38, wherein said second organic group has a shorter chain length or less steric hindrance than said organic group.

50. The separation device of claim 19, wherein n=18 and x=1.

51. The separation device of claim 19, wherein n=8 and x=1.

52. The separation device of claim 50, further comprising a second organic group attached on the carbonaceous material.

53. The separation device of claim 51, further comprising a second organic group attached on the carbonaceous material.

54. The separation device of claim 52, where the second organic group is —Ar—C(CH₃)₃.

55. The separation device of claim 53, where the second organic group is —Ar—C(CH₃)₃.

56. The separation device of claim 5, wherein the organic group comprises —Ar—((CₙH₂ₙ)CN)ₘ, wherein Ar is an aromatic group, n is 0 to 20, and m is 1 to 3.

57. The separation device of claim 5, wherein the organic group comprises —Ar—((CₙH₂ₙ)C(O)N(H)—CₓH₂ₓ₊₁)ₘ, wherein Ar is an aromatic group, n is 0 to 20, x is 0 to 20 and m is 1 to 3.

58. The separation device of claim 5, wherein the organic group comprises —Ar—((CₙH₂ₙ)N(H)C(O)—CₓH₂ₓ₊₁)ₘ, wherein Ar is an aromatic group, n is 0 to 20, x is 0 to 20 and m is 1 to 3.

59. The separation device of claim 5, wherein the organic group comprises —Ar—((CₙH₂ₙ)O—C(O)—N(H)—CₓH₂ₓ₊₁)ₘ, wherein Ar is an aromatic group, n is 0 to 20, x is 0 to 20 and m is 1 to 3.

60. The separation device of claim 5, wherein the organic group comprises —Ar—((CₙH₂ₙ)C(O)N(H)—R)ₘ, wherein Ar is an aromatic group, n is 0 to 20, x is 0 to 20 and m is 1 to 3, and R is an organic group.

61. The separation device of claim 5, wherein the organic group comprises —Ar—((CₙH₂ₙ)N(H)C(O)—R)ₘ, wherein Ar is an aromatic group, n is 0 to 20, x is 0 to 20 and m is 1 to 3, and R is an organic group.

62. The separation device of claim 5, wherein the organic group comprises —Ar—((CₙH₂ₙ)O—C(O)N(H)—R)ₘ, wherein Ar is an aromatic group, n is 0 to 20, x is 0 to 20 and m is 1 to 3, and R is an organic group.

63. The separation device of claim 56, further comprising a second organic group attached on the carbonaceous material.

64. The separation device of claim 57, further comprising a second organic group attached on the carbonaceous material.

65. The separation device of claim 58, further comprising a second organic group attached on the carbonaceous material.

66. The separation device of claim 59, further comprising a second organic group attached on the carbonaceous material.

67. The separation device of claim 60, further comprising a second organic group attached on the carbonaceous material.

68. The separation device of claim 61, further comprising a second organic group attached on the carbonaceous material.

69. The separation device of claim 62, further comprising a second organic group attached on the carbonaceous material.

70. The separation device of claim 63, wherein said second organic group has a shorter chain length or less steric hindrance than said organic group.

71. The separation device of claim 64, wherein said second organic group has a shorter chain length or less steric hindrance than said organic group

72. The separation device of claim 65, wherein said second organic group has a shorter chain length or less steric hindrance than said organic group

73. The separation device of claim 66, wherein said second organic group has a shorter chain length or less steric hindrance than said organic group

74. The separation device of claim 67, wherein said second organic group has a shorter chain length or less steric hindrance than said organic group

75. The separation device of claim 68, wherein said second organic group has a shorter chain length or less steric hindrance than said organic group

76. The separation device of claim 69, wherein said second organic group has a shorter chain length or less steric hindrance than said organic group

77. The method of claim 6, wherein said separation is supercritical fluid chromatography.

78. The separation device of claim 5, wherein the organic group comprises an optically active aminoacid or derivatized aminoacid for the separations of racemic mixtures into their optically pure components.

79. The separation device of claim 5, wherein the organic group comprises cyclodextrin attached through a group —Ar(CH₂)ₙ, where n=0 to 15 for the separations of racemic mixtures into their optically pure components.
